(19) United States
(12) Patent Application Publication
(10) Pub. No.: US 2016/0042469 A1
(43) Pub. Date: Feb. 11, 2016

(54) SYSTEM AND METHOD FOR FINANCIAL TRANSACTION MANAGEMENT

(71) Applicant: WAVE ACCOUNTING INC., Toronto (CA)

(72) Inventors: James LOCHRIE, Calgary (CA); Michael WARKENTIN, Toronto (CA); Nathan DUTHOIT, Toronto (CA); Dieter LIMEBACK, Toronto (CA)

(21) Appl. No.: 14/651,828

(22) PCT Filed: Dec. 12, 2013
(86) PCT No.: PCT/CA2013/050957

§ 371 Date: Sep. 10, 2015

Related U.S. Application Data
(60) Provisional application No. 61/737,640, filed on Dec. 14, 2012.

(51) Int. Cl. G06Q 40/00; G06F 17/30

(52) U.S. Cl. CPC G06Q 40/12; G06F 17/30528; G06F 17/30864; G06F 17/3089; G06F 17/30684; G06F 17/30985; G06F 17/30598

(57) ABSTRACT

A system and method providing a financial transaction management tool operable to provide contextual information relating to particular financial transactions is provided. The financial transaction management tool is operable to highlight associations between bank data, source documents and manual or automated financial data. The financial transaction management tool is further operable to organize accounting information and contextual information into an easy to read format and that operates to assemble and thereby bring together sources relating to a financial transaction so that such sources are easily viewable. In some embodiments of the present invention the multiple sources may be viewable in a single view. The financial transaction management tool is also operable to organize multiple transactions in a single transaction stream.

### CROSS REFERENCE

This application claims priority to U.S. Patent Application No. 61/737,640 filed Dec. 14, 2012 which is incorporated by reference herein.

### TECHNICAL FIELD

The following relates generally to financial transaction management and more particularly to a system and method for financial transaction management that is operable to determine associations between bank data, source documents and manual or automated financial data.

### BACKGROUND

In the U.S. there are over 21 million single-person businesses plus another 4.4 million businesses with fewer than 20 employees. In Canada, more than 11,000 new small businesses are created each month, not including self-employed entrepreneurs.

Small businesses account for 60% or more of global GDP, and about 70% of total worldwide employment. Small to medium sized businesses (“SMBs”) account for 72% of employment in China, 73% in India, and over 80% in Latin America. In Canada 2.63 million Canadians are self-employed, up 10% over the last decade and there are more than 1 million small businesses that have fewer than 50 employees.

Business owners typically do not like to spend time performing accounting tasks and very few do it properly. Most small businesses would like a better picture of their day to day finances and financial transaction records.

Existing accounting applications were designed primarily for accountants, not for business owners. As a result, 67% of small businesses still use spreadsheets to manage their money. Accounting becomes a chore and small business owners avoid doing their books, they don't take advantage of the data they are collecting and what they produce is of limited use to an accountant.

One company offering accounting software is QuickBooks™. QuickBooks by some reports has 85% market share for desktop software. Other software packages, such as Simply Accounting™, exist but don't show any sign of eating into QuickBook's lead.

By some reports, 64% (about 18.6 million) of small businesses use spreadsheets or less sophisticated solutions. The remaining 36% (10.4 million) use some sort of accounting application (most use QuickBooks).

Spreadsheets are cumbersome as accounting solutions and few small business owners have the time to design or use a proper spreadsheet.

There are several companies in the online (cloud/SaaS) accounting space, the following being examples. Xero™ offers online accounting software. Freshbook™ offers cloud accounting services aimed at small businesses. Kashoo™ also offers a cloud based accounting product designed specifically for small businesses. Sage Accounting™ offers a range of accounting and business management software products that are specifically designed to be easy to use. Outright™ provides online bookkeeping services for small businesses.

However, known accounting products may provide assistance with accounting services, but they do so in a manner that fails to provide any context to financial transactions.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect, a financial transaction management tool is provided, the financial transaction management tool comprising: a server computer; one or more databases linked to the server computer; an internet connection whereby one or more records are transferred to the server computer; a transaction processing application operable by one or more processors of the server computer to: apply a transaction detection element to capture information from a loaded record; apply a transaction matching element operable to access additional records and to determine matches between records to identify records corresponding to a single financial transaction; and to store information derived from the loaded record and the additional records, as well as copies of the loaded record and the additional records in the one or more databases; and a user interface operable by one or more processors of the server computer to interactively display the information derived from the loaded record and the additional records to the user.

In another aspect, a system for financial transaction management is provided, the system comprising: a server computer; one or more databases linked to the server computer; an internet connection whereby one or more records are transferred to the server computer; a transaction processing application operable by one or more processors of the server computer to: apply a transaction detection element to capture information from a loaded record selected from among the one or more records; apply a transaction matching element operable to access additional records from among the one or more records, and to determine a match between the loaded record one of the additional records corresponding to a single financial transaction.

In a further aspect, a method for financial transaction management is provided, the method comprising providing a server computer linkable to one or more databases and to an internet connection, whereby one or more records are transferred to the server computer by the internet connection, the server computer enabling, by one or more processors, the operation of a financial transaction management tool operable to: apply a transaction detection element to capture information from a loaded record selected from among the one or more records; apply a transaction matching element operable to access additional records from among the one or more records, and to determine a match between the loaded record one of the additional records corresponding to a single financial transaction.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is an architecture diagram of a financial transaction management system;

FIG. 2 is an architecture diagram further to that of FIG. 1;

FIG. 3 is a method for financial transaction management;

FIG. 4 is another method for financial transaction management;

FIG. 5 is another method for financial transaction management;

FIG. 6 is a screen shot showing a view of multiple financial transactions and that identifies the number of contextual information documents that relates to a particular selected financial transaction; and

FIG. 7 is a screen shot showing an instance whereby two separate transaction records are merged into a single financial transaction.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF PREFERRED EMBODIMENTS

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

There is a need for an accounting product and system that provides a financial transaction management tool that is operable to also provide contextual information relating to particular financial transactions. There is further a need for a financial transaction management tool that is operable to highlight associations between bank data, source documents and manual or automated financial data. There is further a need for a financial transaction management tool that is operable to organize accounting information and contextual information into an easy to read format and that operates to bring together sources relating to a financial transaction so that such sources are easily viewable, and preferably viewable in a single view. There is further a need for a financial transaction management tool that organizes multiple transactions in a single transaction stream

The following provides a system, method and accounting product that provides a financial transaction management tool operable to provide contextual information relating to particular financial transactions. The financial transaction management tool is operable to highlight associations between bank data, source documents and manual or automated financial data. The financial transaction management tool is further operable to organize accounting information and contextual information into an easy to read format and that operates to assemble and thereby bring together sources relating to a financial transaction so that such sources are easily viewable. In some embodiments, the multiple sources may be viewable in a single view. The financial transaction management tool is also operable to organize multiple transactions in a single transaction stream.

The system provided herein may comprise several elements, including a computing device comprising one or more processors and one or more memories, a photo device operable to capture a digital photo, an optical character recognition (OCR) program operable by one or more of the computer processors of the computing device, an Internet gateway connection or a connection to a cloud computing environment accessible by the computing device, one or more databases linked or linkable to the computing device whereby information may be bi-directionally transferred between the computing device and the one or more databases, and a transaction processing application operable as described herein.

The photo device may be any of a camera, a tablet, a smartphone, a cellular phone, or any other device operable to capture a digital photo. The photo device may be operable to upload the digital photo to the computing device directly in some embodiments. The computing device may be any of a smartphone, a laptop computer, a desktop computer, a tablet, or any other computing device having one or more computer processors and memories storing computer instructions operable to cause a software product to operate on the one or more processors. One or more of the one or more databases may be external to the system and may be operated by a third party. The Internet connection may provide access to third party accounting services and/or third party databases.

Through the internet connection the system may access multiple sources of financial data. These multiple sources may provide access to two or more transaction records relating to the same financial transaction. In this manner the system is operable to access and retrieve information relating to a single financial transaction from multiple sources, and is further operable to capture copies of financial transaction records from multiple sources, and all of these records relate to the same financial transaction.

As an example, a user may purchase an item, such as a computer. The user may utilize a credit card to make this purchase. The store where the computer is purchased will produce a receipt for the transaction and will store a copy of this receipt and information regarding the transaction generally. The credit card company will also create a record of the transaction. The user may scan the receipt, or take a photo of the receipt, that is provided to the user. The receipt is then provided to the system so that an OCR is able to scan the receipt and collects information regarding the financial transaction that was the purchase of the computer by the user. This information is utilized to produce a record of the transaction. The system may further access other sources having records of the transaction, such as the credit card company source and the seller company source. These third party transaction records may be accessed by the system, and the information therein may be utilized by the system. As a first step the records from third party sources will be matched to the transaction information stored by the system. Upon a match the original records of the transaction are preserved and information from these records is gathered by the system. The result is the information regarding the financial transaction of the purchase of the computer is obtained by the system and this is further supported by copies of the financial records relating to the transaction, such as the receipt, the credit card records, and the seller company records. The result of obtaining these multiple records from a variety of sources is that contextual information relating to the financial transaction is captured.

In one embodiment of the system, a user may provide a picture of a receipt from a financial transaction. The system may incorporate an OCR program operable to read the content of a document and to extract data from said content. The OCR program may further be operable to create a transaction record based upon the extracted content.

An application may be stored on the device that is used to take the picture that causes the photo to be updated directly from the device to the server. The device may be any device having photo capabilities and the ability to store an application, for example, such as a mobile phone, a smart phone, a tablet, a digital camera, etc. The server will process the picture (perform OCR) to derive information regarding the transaction that the receipt contains and will further store a copy of the receipt.

The system may access bank data and other accounting related data either from a database incorporated in the system, or systems or databases external to the system. For example, the accessed bank data and accounting related data may include invoices, payments, bills or other data or documents. The system may determine and identify related bank data or accounting data from that which is accessed by the system and import said bank data and/or accounting data into the system, as required. The transaction processing application may match the transaction record against the accessed data, including any imported data. The matching may be achieved by a learning process, which implements a learning algorithm or calculation. The result of the learning algorithm or calculation may be a single view of the transaction.

The learning algorithm or calculation may involve the identification of elements in the transaction records, for example, such as an amount, the date of the transaction, a description of the transaction, or any other elements. The learning algorithm or calculation may further involve a review of information relating to previous behaviours of a user engaged in the transaction, for example, such as a review of transactions that the user was engaged in that have previously been manually matched, or other indicators of previous user behaviours. The learning algorithm or calculation may also involve a review of the behaviour of other users, for example, such as a review of transactions that other users have manually matched, or other indicators of behaviours of other users.

Once capturing these types of elements relating to a transaction, the transaction processing application may perform a voting procedure whereby it operates to determine if two transaction records match. The voting procedure may have a weighting of votes that represent input into the determination. For example, the voting process may identify votes from a user's previous activity as counting for more than do votes from other users in the system.

Once a match is determined, the transaction processing application may link the accessed data and the transaction record to create a single transaction profile that may be used for financial purposes. The transaction profile may incorporate the transaction record as well as the accessed data sources that make up the transaction.

Transactions may result from multiple sources, such as the following three sources, for example: transactions that are manually entered into the system by the user; transactions that are imported from an integration (e.g., CashEdge™, Paypal™, etc.); and transactions that are imported from a statement upload. All transactions are stored in one or more databases of the system, such as in a relational database structure, for example. Links between the transactions may be maintained in the database. For example, join tables may be utilized to maintain such links.

The transaction processing application may autocategorize the transaction once the transaction portfolio is generated. The transaction processing application may then accurately analyze the transaction. Autocategorization may be handled in one embodiment of the system by a service, such as CUPID™. Autocategorization may involve a review of categorizations that a user has created or applied in the past, as well as categorizations that other users have created or applied. A match will be determined, and the strength or veracity of the match may be evaluated and qualified. If a good match is achieved the transaction will be categorized. If a good match is not achieved the transaction may remain uncategorized.

Autocategorization may be performed so that an attempt is made to match transactions in accordance with information determined to describe the transaction. Such information may be stored in a description field in the database where the information relating to the transaction is stored. Transactions with identical description field input may be considered to be very likely to form a valid match.

Once a transaction profile is generated the transaction processing application may incorporate the transaction in a list of transactions. Once incorporated in a list of transactions a user may view, edit or manage each of the transactions included in the list, in accordance with access rights provided to a user by a system administrator. The system may further be operable to utilize the transactions, and the transaction profiles related thereto, for financial reporting purposes. A variety of reports may be generated in accordance with embodiments of the system. The system may further utilize the transactions for auditing purposes in the future, and the system may incorporate a variety of auditing tools and options.

While forming a transaction profile the transaction processing application may perform autocategorization of transactions and matching to combine multiple sources of data for a single transaction. This combination forms a transaction profile.

The system provides a user with a transaction screen tool that the user may utilize to manage transactions.

In one embodiment of the system, the financial transaction management tool may be operable to provide accounting services via a cloud computer environment. The financial transaction management tool may further access other accounting services and resources via the cloud computer environment in its operation. The service provided using the system, which may be provided on a SaaS basis, provides an effective computer implemented accounting solution, which may be used for example by smaller businesses (for example businesses having nine or fewer people).

The system permits multiple sources for a transaction to be recognized and recorded. Thus, it provides a benefit and improvement over known pre-existing accounting service systems in that it does not focus upon a single source of transaction information and ignore all of the other sources that provide data, supporting documentation and context for a particular transaction, as the prior art systems do.

Only a single source for a transaction is recognized by the prior art systems noted above. The present system does not function in this manner. Instead, the system seeks, gathers and recognizes multiple sources of data and supporting documentation for a transaction. Furthermore, the system seeks, gathers and recognizes data and documentation that provide context for a transaction. This provides a fuller view of the transaction than is achieved by prior art systems noted above. The system further achieves full auditability in a reduced view or single view format. Maximum information is extracted regarding a transaction which allows for an accurate financial picture to be revealed to a user relating to a transaction.

The user can therefore view and understand a transaction in its context due to the data, supporting documents and multiple sources for the transaction that are collected by the system. This provides more than merely information relating to a transaction because not only information solely relating to the transaction is collected. Information relating to the context of the transaction may also be gathered. For example, context may be provided by data and documents relating to the transaction that are not specifically data or documents that solely reflect the transaction record.

Context is further provided by the multiple sources of data because different sources may offer specific information that other sources do not. For example, transaction information gathered from sources such as Paypal™ and Etsy™ may include information regarding the user to whom the product or service was sold. Moreover, sources that relate to the receipt for a transaction will incorporate a digital copy of the actual receipt as a source document. The collection of data relating to a single transaction from multiple sources offers the system the potential to collect a wide range of information relating to the transaction. Having a wide range of information regarding a transaction means that aspects and elements of the transaction relating to the context of the transaction are captured and can be provided by the system for a variety of uses.

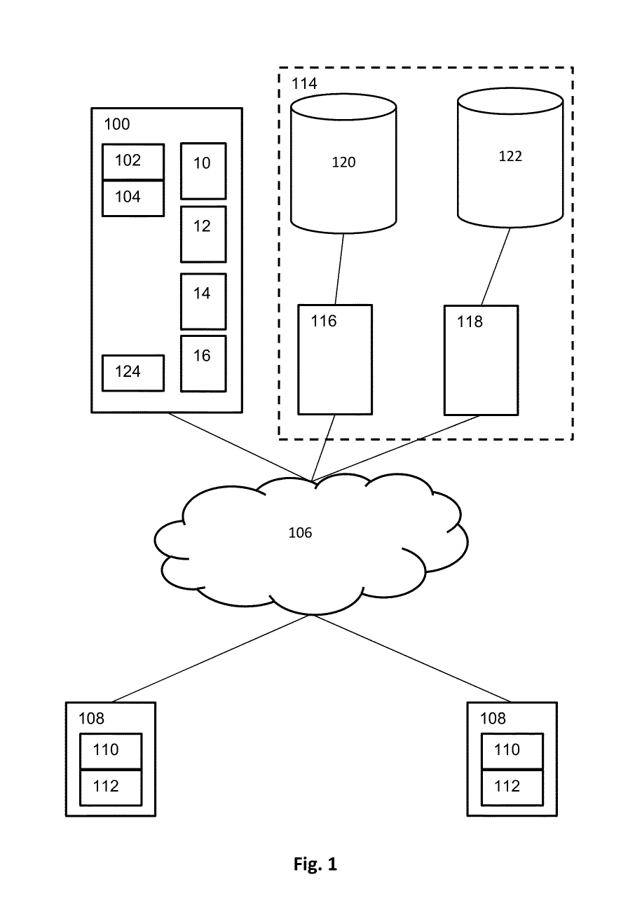

Once the system collects information relating to a transaction several actions may be applied to the transactional information for the purposes of accounting, audits, reporting, analysis or other purposes. For example, the system may be operable to utilize the transaction information perform accounting actions disclosed in PCT Application No. PCT/CA2011/001223, the contents of which are incorporated herein by reference. The system may be configured to provide a variety of functions and options. Some of these options may be provided as modules, and some modules may offer specific functions to various types of users, as shown in FIGS. 1a-1e.

An exemplary system in accordance with the foregoing is shown in FIG. 1. The system comprises a server 100, the server 100 comprising a processor 102 and memory 104, the memory 104 storing instructions operable to configure the processor 102 to perform the functionality described herein. In particular, the server 100 comprises or is linked to the transaction processing application 124.

The server 100 is accessible to users via a network 106, such as the internet. Users may access the server 100 from network connected computing devices 108, which, as previously described, may be any of a smartphone, a laptop computer, a desktop computer, a tablet, or any other computing device having one or more computer processors 110 and memories 112 operable to cause a software product or application to operate thereon. The computing device 108 is configured to access a user interface provided by or through the server, such as by a web browser for example, or programming interface to communicate with the server 100.

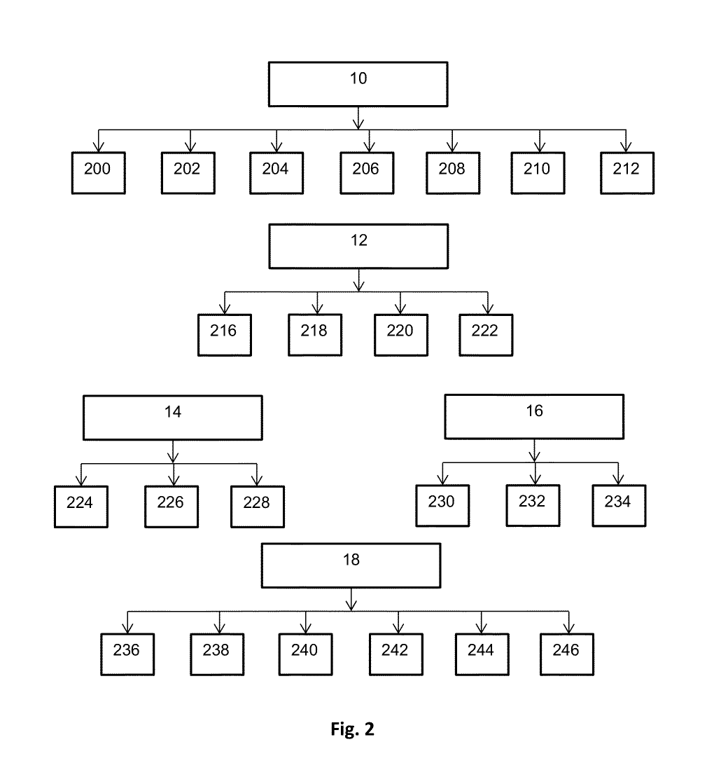

The server 100 implements a plurality of modules enabling the functionality described herein. The modules comprise a business module 10, personal module 12, public module 14, growth apps module 16 and integrations module 18. Each such module comprises a plurality of functional units each providing a function, as described below and shown in FIG. 2. Additionally, the server and/or application enables additional functionality as previously described, including, for example, OCR or other user input recognition and processing.

The server is further linked by network connection to one or more third party devices 114. The third party devices comprise bank servers 116 and transaction servers 118, each comprising or being linked to a database 120, 122 providing access to financial transaction data. Bank servers provide bank data and other accounting related data as previously described. Transaction servers provide financial data as previously described.

In one embodiment of the system, as shown in FIG. 2, a business module 10 may be provided for use by businesses, including small and mid-sized businesses. The business module may provide the interface enabling access to users via a dashboard 200 from which a user may select a variety of operations. The business module further provides an interface to the transaction processing application 124, enabling the system and users to perform the transaction functions 202 described herein, whereby transaction records from multiple sources are matched to identify a range of information relating to a financial transaction. The range of information and multiple sources may further provide context to a financial transaction, as described herein. Information regarding one or more financial transactions may be accessed by a user of through the business module.

The business module may further provide users with invoicing functions 204, billing functions 206, and accounting functions 208. Each of these functions may utilize information and records relating to financial transactions, as are collected by the system, as is described herein. The financial transactional information stored in the one or more database may be accessed by these functions in the performance of invoicing, billing and accounting functions.

The business module may further provide a user with the capability of generating a variety of reports 210. The system may be configured to generate specific reports, and may further be operable so that a user may design a report layout himself or herself.

The business module may further provide general functions, such as payroll 212 and receipt functions 214.

The system may provide a personal module 12 that offers access to particular functionalities by way of a dashboard 216. This module may be utilized by individuals for tracking financial transactions, rather than businesses, and therefore the dashboard may be tailored to offer functionalities applicable to an individual's accounting needs and requirements.

The personal module also provides an interface to the transaction processing application 124 to offer access to the financial transaction operabilities 218 of the system, as described herein. The personal module may also offer access to investment functions 220 and personal payroll functions 222. By utilizing the personal module an individual may enjoy aspects of the system that are particularly applicable to an individual's accounting needs, and may particularly utilize the financial transaction functions of the system as are described herein.

A public module 14 may be offered by the system for use by members of the public. The public module may incorporate a public site 224 that may be accessible as a website. The public module may provide access to a professional network 226, and may further offer support functions 228.

A growth apps module 16 may be offered by the system whereby applications may be available to be loaded to a device, for example such as a laptop, a mobile telephone, a smart phone, a tablet, a desktop computer, or any other device. The apps may be functionable with various computer platforms and software, for example, such as Windows™, Google™ Chrome™, and Apple™ products, or other platforms and software. The apps may be accessible through app stores related to any of said platforms or software, for example, such as the Windows Store™ 230, Chrome Store™ 232, App Direct™ 234, or other app stores. The apps may also be accessible through other sources, such as from websites, etc.

Once an app linked to the server is loaded on a device the device will be operable to access the server and thereby access the functions of the server.

After an app is loaded on a device, that device will further be operable to engage in the functionalities provided by the server. For example, the device may be operable to send digital photos of receipts to the server, as well as other functions of the server.

An integrations module 18 of the system may provide access to a variety of integrations. Such integrations may be utilized to provide or support particular functions of the system, as described herein. For example, integrations may be accessed to obtain transaction sources and records. The integrations may be varied, and for example, may include PayPal™ 236, Shoeboxed™ 238, Google Apps™ 240, Cheques™ 242, Etsy™ 244, Google Docs™ 246, or other integrations.

Embodiments of the system may provide access to all of the modules, or different combinations of modules. A skilled reader will recognize the variety of options for module based configurations that may be represented by embodiments of the system.

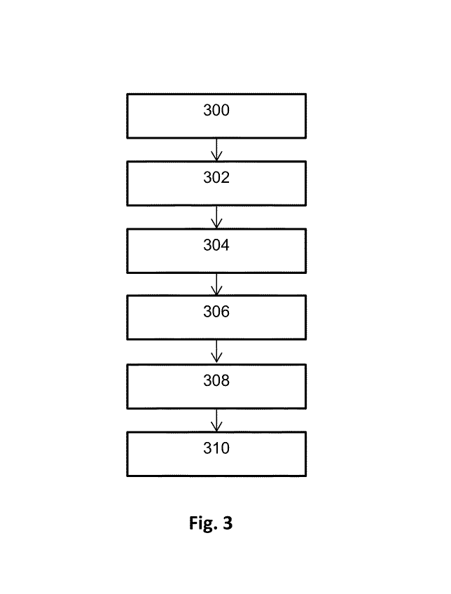

FIGS. 3, 4 and 5 depict examples of a process of the financial transaction aspect of the system as provided by the financial transaction management tool. It will be appreciated that a suitable implementation described by these examples may be provided by a finite state machine. In the examples of FIGS. 3, 4 and 5, AccountA and AccountB are accounts tied to a financial institution; AccountC is an account not tied to a financial institution; and BR1, BR2 and BR3 are bank records for AccountA, AccountB and AccountC, respectively. The transaction processing application of the system takes action to match transactions, the specific action depending upon whether it is apparent to the system that two transactions should be matched and/or whether the server has been provided linked access to financial institutions and/or transaction sources exposing transaction data capable of being automatically matched and/or whether user intervention is desirable or necessary to verify the matching of transactions.

In accordance with the illustrated method, the user may be required to approve some actions, whereas other actions may be automatically undertaken by the system. A skilled reader will recognize that different configurations of automatic actions, and user approval required actions may be included in embodiments of the system. An example of this process is provided below. This example includes references to specific elements, such as accounts (e.g., AccountA and AccountB, etc.), amounts, and other specific elements. These specific element references are provided to clarify the example, and a skilled reader will recognize that elements other than the specific elements referenced in this example may be incorporated or utilized by other embodiments of the system.

As an example of the function of the transaction processing application, as depicted in FIG. 3, at block 300 two bank records may be obtained by the transaction processing application, for example, such as a record for −100 from AccountA (BR1), and record for +100 from AccountB (BR2). As these bank records are loaded to the transaction processing application, at block 302, a transfer detection element of the transaction processing application may detect a possible transfer between AccountA and AccountB is represented by the two bank records. At block 304, the transaction processing application may create a transfer and attach the two bank records. At block 306, the transaction processing application may recognize that transfer auto detection occurred for the two transactions. At block 308, the user may be asked to approve or cancel the detection of a transfer. To approve, at block 310, the user may click or otherwise indicate an approval.

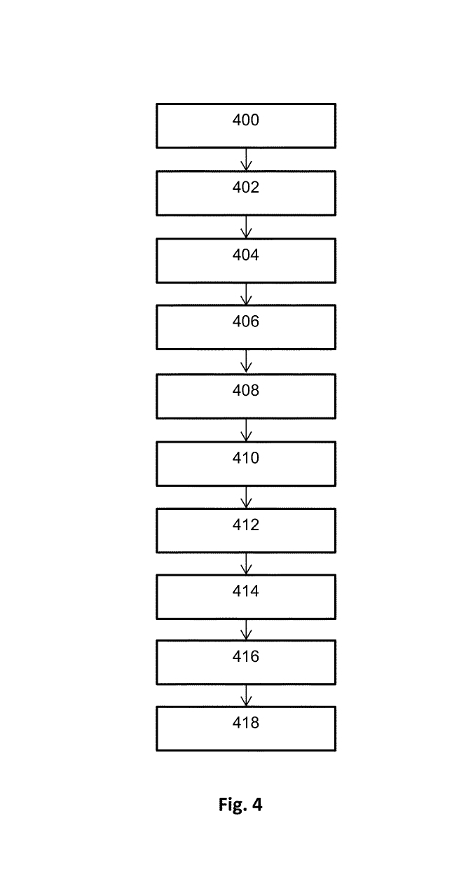

Referring now to FIG. 4, the transaction processing application may alternatively receive an untouched imported transaction, for example, such as a picture of a receipt, and the transaction processing application may not have any indication of the other portion of the transaction. For example, at block 400, the system may receive a bank record, BR1, showing the transfer of 100 from AccountA, without any indication of the account that the 100 is to be transferred to. At block 402, the user may have the option to mark the record as a transfer.

The user may select, at block 404, the account that is related to the other portion of the transaction, for example, the account that the amount should be transferred to. As another option, the user may select the other account and further indicate, at block 406, that the transaction should wait to be imported, so that the amount is waiting to be imported to the other selected account. At block 408, the transfer detection element of the transaction processing application may detect a possible match for the transfer when loading the initial transfer record that is related to only one portion of the transaction. For example, the transfer detection element may detect a possible account where the 100 transferred from AccountA, as is provided in the bank record loaded to the system, is to be transferred to. The possible account may be AccountB, for example. At block 410, the transaction processing application may provide a possible match record showing a possible match for the transaction between an amount transferred from the account (AccountA) shown on the bank record (BR1) loaded on the system, that is a record for the same amount being transferred to another account (AccountB), as is shown on a bank record (BR2) identified by the transfer detection element. At block 412, the transaction processing application may optionally require the user to approve or cancel the possible match. If the user approves the possible match the transaction may be imported at block 414.

A financial transaction record is stored that shows both portions of the transaction, being the transfer from one account to another account. For example, the transfer of 100 from AccountA shown on a bank record (BR1), and the transfer of 100 to AccountB as shown on another bank record (BR2).

Once the user approve the match, then the user has also approved the recordation of the transaction as having two sides—a transfer from and a transfer to—and for both of these sides to be saved as linked and related to each other in the system. Thus, at block 412, the user selects both the account for the originally unknown side of the transaction, as well as the matching operation, whereby the account of the originally unknown side of the transaction becomes known, and the two sides of the transaction become linked and related to each other.

It is also possible for a user to choose another account as the originally unknown side of the transaction. For example, if at block 412 the user did not approve the automatically generated match, or where the system is not configured to determine an automatic match under the circumstances, then at block 414, the user may select AccountC as the destination for the transfer of 100 from AccountA. In this example, the user may manually indicate the match, rather than choosing a matching option provided by the transaction processing application. At block 416, the user may select the account. At block 418, the user may select manual creation of the match. The result is that a matching occurs and a transaction is confirmed between two accounts, based on information manually provided by the user.

Thus, some transaction records may be uncategorized. Moreover, a transaction matching element of the transaction processing application may access a variety of sources to determine possible matches for the system. In another embodiment, the system may engage in autocategorization. It is possible for two transactions to be imported to the system, and transfers to be detected relating to each of these transactions. If the transfers are detected to be related the transaction processing application may auto approve the transfers as representing both sides of a financial transaction, meaning a transfer of an amount from an account and to another account.

As previously described, the transfer detection element in this instance may have automatically detected that the two loaded transactions were related. A user may have been asked to approve the transfer in some embodiments. A user may further have been asked to approve the importation of the transaction in some embodiments. The user may further select the appropriate accounts and indicate that the two originally received transactions are a match and select these as matching transactions, in some embodiments.

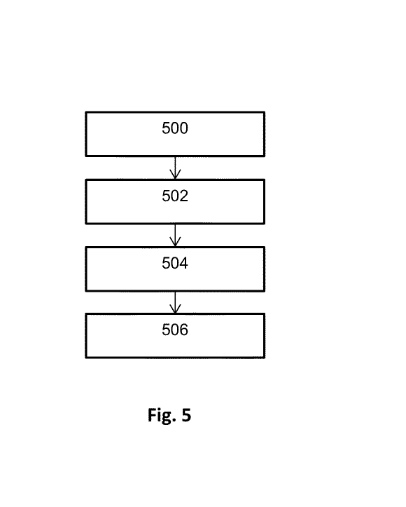

Referring now to FIG. 5, the transaction processing application may further undertake autocategorization that, at block 500, detects one side of a transfer and declares this to be a transfer transaction, whereby an amount is being transferred. In this instance the user may, at block 502, select the other account where the amount is to be transferred. At block 504, the user may mark the original loaded record as a transfer. At block 506, the user may further mark the transfer to wait to be imported.

The transaction processing application may further utilize autocategorization to detect the other side of the transaction and load the relevant record to the system. This record may be approved to complete the transaction. The transaction processing application may also utilize autocategorization to detect the other side of the transaction and load the relevant record to the system, but the user may be required to manually create the transfer.

Further, the user may create a transfer manually with another business. The transaction may be created on the other business. This may occur in accordance with the user selecting the option to create a transaction manually.

Therefore, the user has a variety of options regarding functions and uses of the present system. A skilled reader will recognize that the examples provided herein are merely some of the possible options.

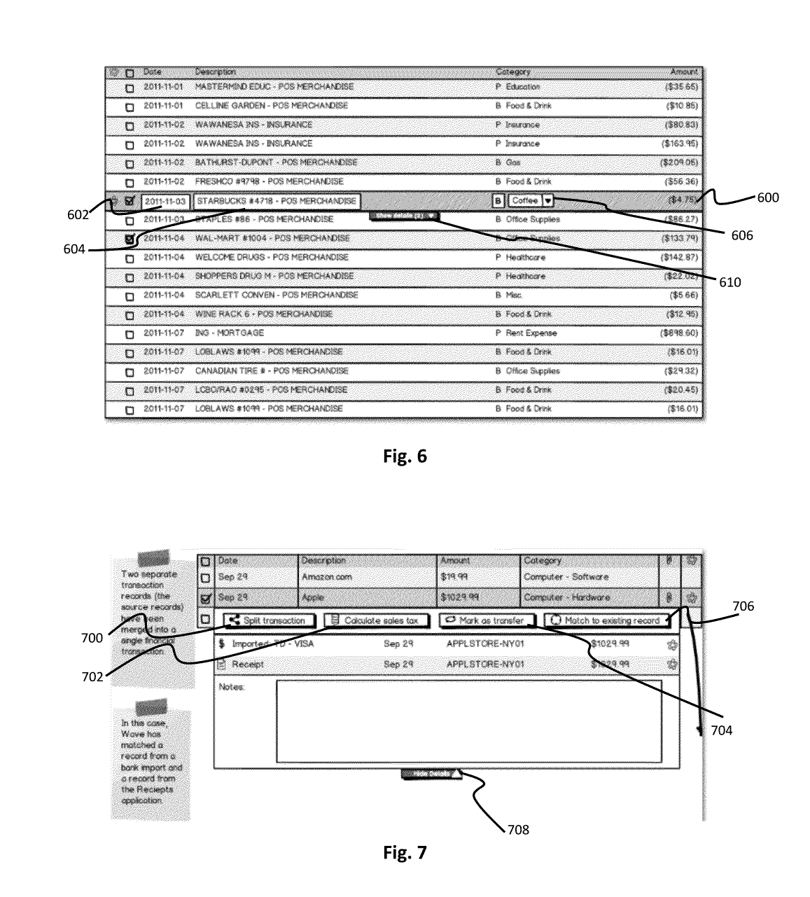

The system may further provide a variety of views for the purpose of matching transactions, as well as reviewing stored transaction details. An example of on such view is shown in FIG. 6, wherein a list of transactions is shown, and these are selectable for further work and review by a user. For example, as shown, one or more specific transactions 600 may be selectable and editable by the user, including editing of transactional information (date of transaction 602, vendor identifier/name 604) and category 606 for transaction. A command 608 may also be made available to enable the user to access further available details of the transaction.

Another view is shown in FIG. 7, wherein two separate transaction records, that are source records, are shown as merged into a single financial transaction. This may occur due to the system functioning to match a record from a bank import and a record from a receipts application. This is just one example of the possible matching that may be undertaken by the system. The system is operable to match a variety of types of records to determine both sides of a single financial transaction. The view shown further enables the user to easily split the transactions 700, calculate sales tax 702, mark the transactions as a transfer 704 or match the transactions to an existing record 706. A command 708 may also be made available to enable the user to access further available details of the transaction.

Other views of transaction records, either for purposes of managing the records, or merely viewing the records, may be provided by the system. As example, the system may be operable to view transactions, categorize transactions, edit transactions inline, edit transaction details, bulk edit transactions, delete transactions, bulk delete transactions, add transactions, mark transactions as transfers, manually match transactions, automatically match transactions, match transactions as new payments, approve or decline matched transactions, move transactions to another business, split transactions, calculate sales tax, filter transactions, refresh Fl accounts, and import transactions.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It should be understood that the present invention may be extended by linking the invention with other technologies or processes useful in the monitoring, control or management of a variety of devices, for a variety of purposes.

We claim:

1. A financial transaction management tool, comprising:
a. a server computer;
b. one or more databases linked to the server computer;
c. an internet connection whereby one or more records are transferred to the server computer;
d. a transaction processing application operable by one or more processors of the server computer to:
i. apply a transaction detection element to capture information from a loaded record;
ii. apply a transaction matching element operable to access additional records and to determine matches between records to identify records corresponding to a single financial transaction; and to store information derived from the loaded record and the additional records, as well as copies of the loaded record and the additional records in the one or more databases; and
e. a user interface operable by one or more processors of the server computer to interactively display the information derived from the loaded record and the additional records to the user.

2. A system for financial transaction management, comprising:
a. a server computer;
b. one or more databases linked to the server computer;
c. an internet connection whereby one or more records are transferred to the server computer;
d. a transaction processing application operable by one or more processors of the server computer to:
i. apply a transaction detection element to capture information from a loaded record selected from among the one or more records;
ii. apply a transaction matching element operable to access additional records from among the one or more records, and to determine a match between the loaded record one of the additional records corresponding to a single financial transaction.

3. The system of claim 2, wherein the records are provided by a plurality of sources of financial data.

4. The system of claim 2, wherein at least one of said matches comprises a record including information obtained by an optical character recognition of a transaction document.

5. The system of claim 2, wherein the determining of the match comprises applying a learning process.

6. The system of claim 5, wherein the learning process comprises identifying and processing elements corresponding to the loaded record.

7. The system of claim 6, wherein the elements comprise at least one of: amount, date, and description.

8. The system of claim 5, wherein the learning process comprises determining a match based at least in part on past transaction matchings by a user.

9. The system of claim 5, wherein the learning process comprises determining a match based at least in part on past transaction matchings by a plurality of users.

10. The system of claim 5, wherein the learning process comprises determining a match based at least in part on applying a weighting or voting system to determine how closely two different financial records.

11. The system of claim 2, wherein matched transaction are autocategorized.

12. The system of claim 11, wherein the autocategorization is based at least in part on a past manual categorization from a user.

13. The system of claim 11, wherein the autocategorization is based at least in part on a past manual categorization from a plurality of users.

14. The system of claim 2, wherein the records transferred by internet connection are transferred from one or more third party data sources.

15. A method for financial transaction management, comprising providing a server computer linkable to one or more databases and to an internet connection, whereby one or more records are transferred to the server computer by the internet connection, the server computer enabling, by one or more processors, the operation of a transaction processing application operable to:
a. apply a transaction detection element to capture information from a loaded record selected from among the one or more records;
b. apply a transaction matching element operable to access additional records from among the one or more records, and to determine a match between the loaded record one of the additional records corresponding to a single financial transaction.

16. The method of claim 15, wherein the records are provided by a plurality of sources of financial data.

17. The method of claim 15, wherein at least one of said matches comprises a record including information obtained by an optical character recognition of a transaction document.

18. The method of claim 15, wherein the determining of the match comprises applying a learning process.

19. The method of claim 18, wherein the learning process comprises identifying and processing elements corresponding to the loaded record.

20. The method of claim 19, wherein the elements comprise at least one of: amount, date, and description.

21. The method of claim 18, wherein the learning process comprises determining a match based at least in part on past transaction matchings by a user.

22. The method of claim 18, wherein the learning process comprises determining a match based at least in part on past transaction matchings by a plurality of users.

23. The method of claim 18, wherein the learning process comprises determining a match based at least in part on applying a weighting or voting system to determine how closely two different financial records.

24. The method of claim 15, wherein matched transaction are autocategorized.

25. The method of claim 24, wherein the autocategorization is based at least in part on a past manual categorization from a user.

26. The method of claim 24, wherein the autocategorization is based at least in part on a past manual categorization from a plurality of users.

27. The method of claim 15, wherein the records transferred by internet connection are transferred from one or more third party data sources.
